(19) United States
(12) Patent Application Publication
(10) Pub. No.: US 2009/0158602 A1
(43) Pub. Date: Jun. 25, 2009

(54) MEASURING DEVICE

(76) Inventor: William A. LOCKYER, Fiddletown, CA (US)

Correspondence Address: GROSS & ASSOCIATES, 1415 L STREET SUITE 1000, SACRAMETO, CA, 95814, US

(21) Appl. No.: 11/960,458

(22) Filed: Dec. 19, 2007

(51) Int. Cl. G01B 3/14; G01B 3/00

(52) U.S. Cl. 33/1 B; 33/562

(57) ABSTRACT

A measuring device for sheet material, which comprises a first portion being planar and having a length, a width and a first surface. The device also includes a second portion being planar and having a first surface, wherein the second portion removably connects to the first portion in a first position along the length and removably connects to the first portion in a second position along the width within the same plane. The first and second portions have measuring indicia imprinted on the first surfaces of the first and second portion. Further, at least one of the first and the second portions includes a first and second sub-portion, wherein the first and second sub-portions are each removably connected to each other and to at least one of the first and second portions in a third position and removably connects to a fourth position within the same plane.

### BACKGROUND OF THE INVENTION

1. Field of Invention

The present invention relates to a device which provides from a single instrument a multi-piece measuring device for use with measuring and cutting sheet material. Specifically, this invention is an improvement to a measuring device employed in quilting and other crafts for cutting, measuring, or marking of a variety of materials such as cloth fabric, paper or plastic.

2. Description of Related Art

Many devices exist to aid a craftsman in the measuring and cutting of sheet material, such as cloth fabric, paper or plastic. In the field of quilting a variety of conventional devices are available. One such device, described in U.S. Pat. No. 7,185,441 by William A. Lockyer, includes a top plate with indicia, which is incorporated herein by reference in its entirety.

The U.S. Pat. No. 7,185,411 device and other similar conventional devices fail to provide a measuring device from a single planar plate that provides the craftsman many choices of measurement templates in a variety of sizes. The craftsman must carry a multiple of assorted conventional devices to meet the measuring and cutting needs of the art.

Further, conventional measuring devices lack a variety of features that allow creation of different tools from a single device. For example, conventional measuring devices are often of a size as to not permit ease of portability, especially if the device is to be employed as a standard 6×24 inch measuring device for quilting. Another example is that conventional measuring devices do not permit an arrangement of a single unit to allow creation of a ninety degree angle for cutting, measuring, or employing as a template. The necessity of having several devices for any given quilting project is tedious as well as unduly expensive.

### SUMMARY OF INVENTION

It is an object of the present invention to overcome the drawbacks and shortcomings of conventional devices. The present invention provides a multifaceted measuring device for use in the field of quilting. The present invention provides the craftsman one tool that can be used for a variety of measurements as well as a cutting guide.

In the craft of quilting, the continuous use of repetitive patterns in squares, rectangles, right angles, 30, 45 and 60 degrees angles are common. Having one tool that can provide the craftsman with the ability to measure and cut these various patterns is of a great advantage. The present invention provides that advantage.

The present invention further provides an embodiment that permits a user to measure 12×12, 6×12, 6×24, or 6×18 all from a single planar tool. This in combination with the ability to measure angles all with the same instrument saves time and expense for the quilting artisan.

The present invention is a device that can be used in conjunction with a device as listed in U.S. Pat. No. 7,185,441. The present invention is an improvement upon the top plate described in the U.S. Pat. No. 7,185,441 device and enhances the utility of the U.S. Pat. No. 7,185,441 device.

The present invention provides a measuring device for flat sheet material, which comprises a first portion being planar and having a length, a width and a first surface. The embodiment further includes a second portion being planar and having a first surface, wherein the second portion removably connects to the first portion in a first planar position along the length and removably connects to the first portion in a second position along the width within the same plane. The first and second portions have measuring indicia imprinted on the each of the first surfaces of the first and second portion.

Additionally, the present invention, in an alternative embodiment is a device for measuring flat, flexible sheet material that comprises a main body being planar and having a length, a width and a first surface, wherein the main body has at least two portions and the two portions are removably connectable to each other in a first position along the length and can be removably connected to each other along the width in a second position. The first surface of the main body also includes indicia for measuring.

Still further, in an alternative embodiment, the present invention provides for a multi-pieced measuring device for flat, flexible sheet material. The device includes a planar member having four removably connected portions and, a first surface and measuring indicia imprinted on the first surface. Additionally, a plurality of connectors is disposed on the planar member and operably configured to connect the four removably connected portions in a first planar position and removably connectable in a second planar position.

### BRIEF DESCRIPTION OF FIGURES

Various exemplary embodiments of this invention will be described in detail, with reference to the following figures, wherein:

FIG. 1 is a perspective view of a device made according to this invention shown in a first position;

FIG. 2 is a top view of the device of FIG. 1 in the first position;

FIG. 3 is a top view of the device of FIG. 1, shown in two parts;

FIG. 4 is a top view of the device of FIG. 1 in a second position;

FIG. 5 is a top view of the device of FIG. 1 in a third position;

FIG. 6 is a cross-section view of a connector used in the device of FIG. 1, taken along the line 6-6 in FIG. 5;

FIG. 7 is a perspective view of an alternative embodiment of a device made in accordance with this invention, shown in a first position;

FIG. 8 is a top view of the device of FIG. 7, shown in three parts;

FIG. 9 is a top view of the device of FIG. 7 in a second position;

FIG. 10 is a top view of the device of FIG. 7 in a third position;

FIG. 11 is a top view of the device of FIG. 7 in a fourth position;

FIG. 12 is a top view of the device of FIG. 7 in a fifth position;

FIG. 13 is a detailed view of a connector used in the device of FIG. 7 in an open position;

FIG. 14 is a detailed view of a connector used in the device of FIG. 7 in a closed position;

FIG. 15 is a top view of an alternative embodiment of a device made in accordance with this invention, shown in a first position;

FIG. 16 is a top view of the device of FIG. 15, shown in four parts;

FIG. 17 is a top view of the device of FIG. 15 in a second position;

FIG. 18 is a top view of the device of FIG. 15 in a third position;

FIG. 19 is a top view of the device of FIG. 15 in a fourth position;

FIG. 20 is a top view of the device of FIG. 15 in a fifth position; and,

FIG. 21 is a cross-section view of a connector used in the device of FIG. 15, taken along the line 20-20, in FIG. 15.

### DETAILED DESCRIPTION OF THE INVENTION

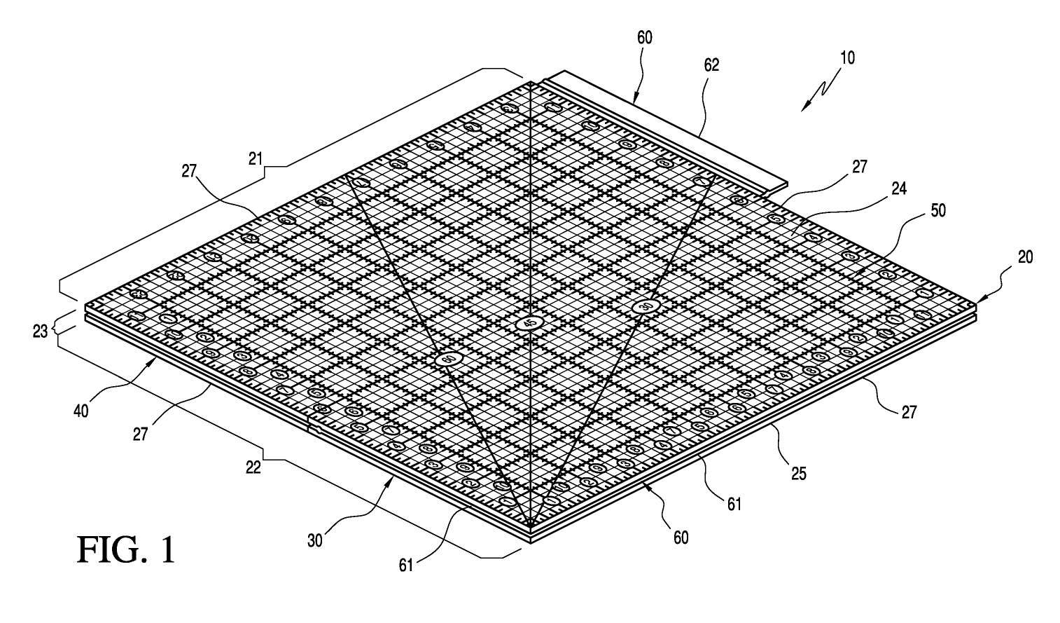

The present invention provides a device 10, as shown in FIGS. 1 through 5, wherein the device 10 is used for measuring flat sheet material. More specifically, the device 10 has particular advantages for use in the field of quilting.

Referring to FIGS. 1 through 5, the device 10 includes a first member 20. The first member or main body 20 has a first portion or first half 30 and a second portion or second half 40. To provide orientation, the first portion 30 is also called the bottom half and the second portion 40 is also called the top half. However, it should be appreciated that the use of terms bottom and top halves do not limit the placement or orientation of the first and second portion 30 and 40. Further, for simplification of discussion, left, right, top, bottom, vertical and horizontal will be used for orientation purposes. However, these terms are for reference only and do not limit the present invention.

The first member or planar member 20 has a length 21, a width 22 and a thickness 23. Additionally, the planar member or main body 20 has a first and second surface 24 and 25 respectively. The first portion 30 and the second portion 40 are removably connected together by a plurality of connectors 60 to form the first member 20 of device 10. The planar member 20 also includes measuring indicia 50 printed on a first surface 24. Additionally, the first member 20 has a perimeter 27.

In the present embodiment, as shown in FIG. 1, the planar member 20 has a generally square shape. However it should be appreciated that in other various exemplary embodiments the planar member could be of other geometric shapes, such as for example a rectangle. Further, in the present embodiment the planar member 20 has the dimensions of twelve inches by twelve inches. Similarly, it should be appreciated that in other various exemplary embodiments, other dimensions may be used.

Further, in the present embodiment, the first member 20 is a transparent, solid polymer resin. This permits the user to see through the device 10 to measure flat sheet material placed below the device 10. It should be appreciated that in other various exemplary embodiments, the first member is not transparent and constructed out of other materials common in the art.

The first portion 30 and the second portion 40 together make up the planar member 20. In the present embodiment the first and second portions 30 and 40 are of equal sized rectangles. However, it should be appreciated that in other exemplary embodiments, the first and second portions could be of other shapes, for example, square.

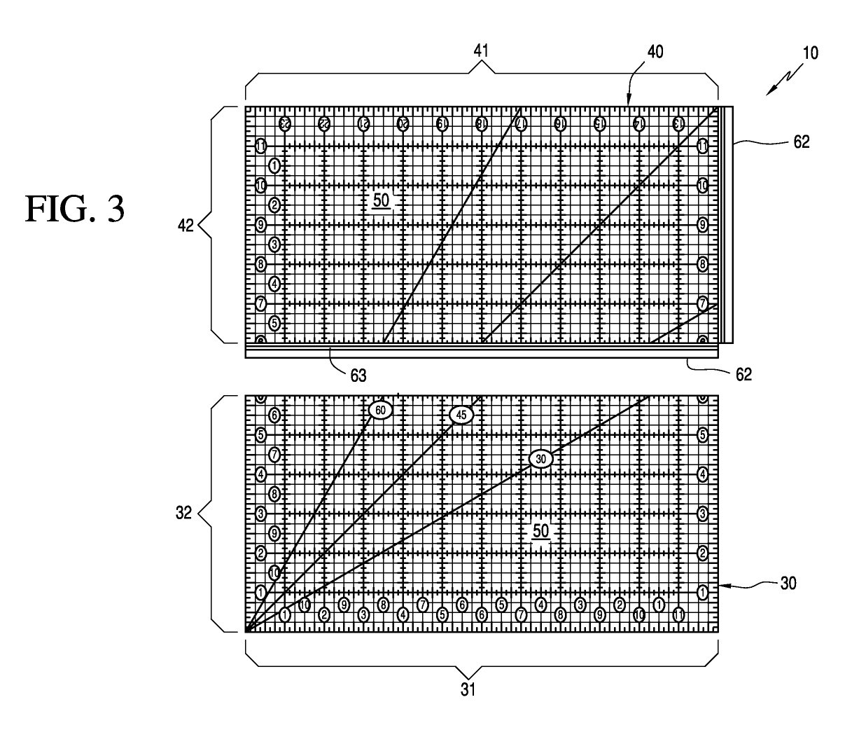

Referring now to FIGS. 3 through 6, the first portion 30 includes a length 31, a width 32 and a thickness 33 (FIG. 6). The second portion 40 also includes a length 41, a width 42 and a thickness 43 (FIG. 6). In the present embodiment, the lengths 31, 41, widths 32, 42 and thicknesses 33, 43 of the first and second portions 30 and 40 are the same. It should be appreciated that in other various exemplary embodiments these dimensions do not have to be the same. Further, the first and second portions each include a perimeter 37 and 47 respectively.

The first and second portions 30 and 40 are removably connected together by the connector 60. The connector 60, as shown in FIG. 6 comprises a first or female part 61 and a second or male part 62.

It should be appreciated that in other various exemplary embodiments, many different types or styles of connectors may be used. For instance, a snap type system may be employed similar to the one in the U.S. Pat. No. 7,185,441 device. Some other exemplary examples will be discussed below. It should be understood that other types of planar member joining systems common in the art may be used.

In the present embodiment, the plurality of connectors 60 is a tongue and groove type connector. The female part 61 of the plurality of connectors 60 is disposed along the perimeter 37 of the first portion 30 as shown in FIG. 1. The male part 62 of the plurality of connectors is disposed along the bottom length 41 and right width 42 of the perimeter 47 of the second portion 40, as shown in FIG. 3.

The male part 62 of the connector 60, as shown in FIG. 6, includes a raised portion 63. The male part 62 and the raised portion 63 are operably configured to fit into the female part 61.

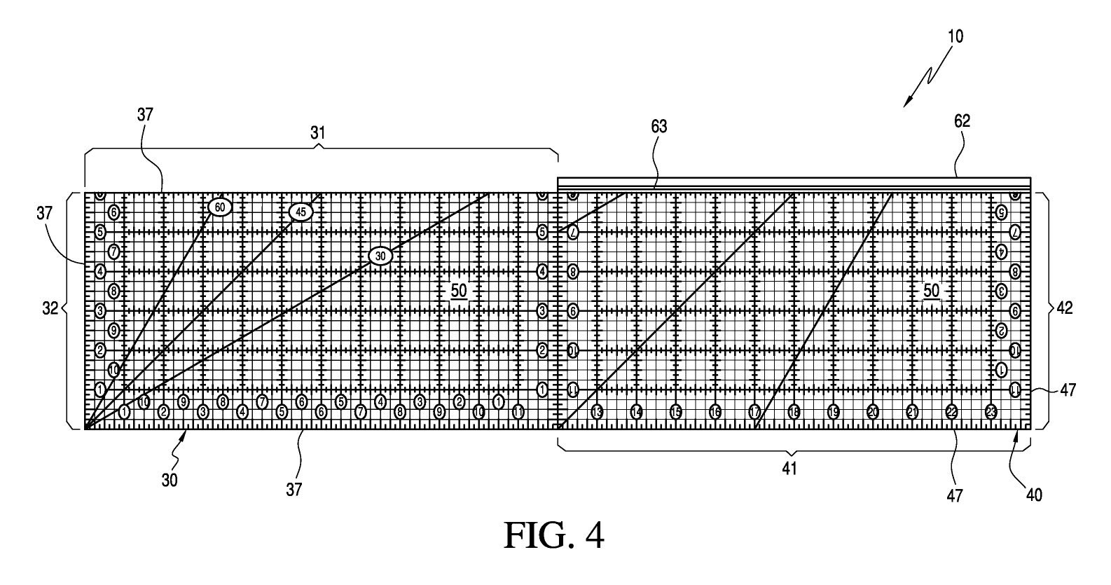

This configuration of the plurality of connectors 60 allows the second or top portion 40 to be connected to the first or bottom portion 30 in a variety of positions within the same plane. In a first planar position, as shown in FIG. 1, the device 10 forms a twelve by twelve square. In a second position, as shown in FIG. 4, the right width 42 of the top portion 40 is connected to the right width 32 of the first portion 30, allowing the device 10 to form a six by twenty-four inch rectangle.

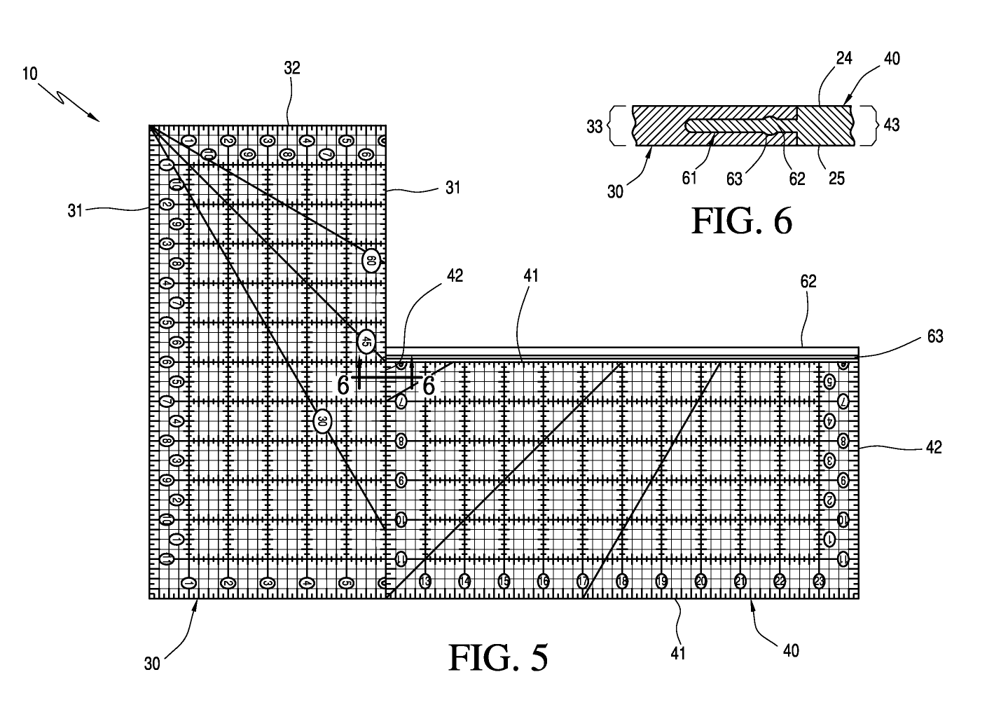

FIG. 5 shows a third position, wherein the bottom portion 30 is rotated clockwise ninety degrees and the top portion 40 is rotated one hundred eighty degrees. The right width 42 of the top portion 40 is disposed on the top length 31 of the bottom portion 30, wherein the device makes an L-shape eighteen inches high by twelve inches wide. This third position could be rotated or adjusted as required by the user. It should be appreciated that the top portion 40 could be placed anywhere along the length of the bottom portion 30 as desired by the user.

An advantage of the device 10 having the tongue and groove type connectors 60 in the present embodiment, is that the user can quickly remove the second portion 40 and align the second portion 40 with the first portion 30 in any of the variety of positions within the same plane. The device 10 is secure with no slipping as the user marks the material being measured or cut.

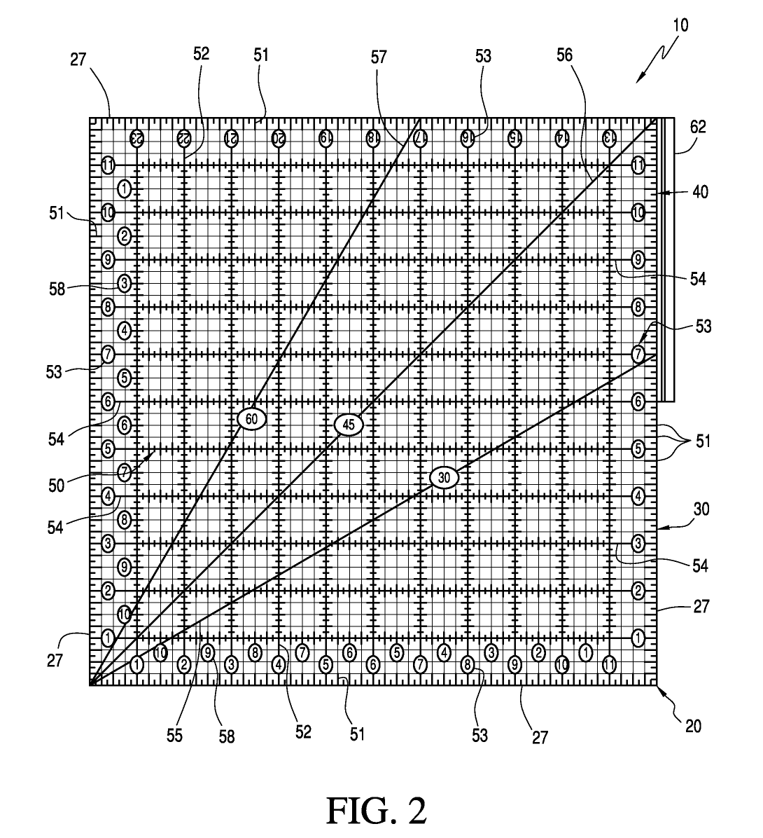

Referring again to FIG. 2, the indicia 50 includes hatch marks 51 separated by ⅛^{th} inch along the perimeter 27. Hatch marks 51 along the bottom connect to hatch marks 51 along the top by vertical ruled lines 52. Similarly, hatch marks 51 along the left connect to hatch marks 51 along the right by horizontal ruled lines 54. The ruled lines 52 and 54 are at ninety degrees angles and therein create a grid line of square shapes on the surface of the first member 20, for accuracy in measuring with the device 10. The indicia 50 on the first member 20 in the present embodiment are in English units. However it should be appreciated that metric units could also be employed.

The indicia 50 further includes a set of angled lines, 55, 56, and 57. The set of angled lines 55, 56, and 57 begin at a corner of the perimeter. In this example, the corner is the bottom left. The set of angled lines 55, 56, and 57 are set at angles 30, 45 and 60 degrees respectively. Additionally, each angled line 55, 56 and 57 may be marked with a circled angle number along the lines 55, 56 and 57. Each angled line 55, 56, and 57 may be further delineated by employing distance hatch marks, dots or numbers along each of the angled lines 55, 56 and 57.

Near the extremities of each of the vertical and horizontal ruled lines 52 and 54 along the left perimeter 27 and along the bottom perimeter 27 are incremental circled marker numbers 53 for use in measuring with the device 10. At points exactly between incremental circled marker numbers 53 are decremental circled marker numbers 58. The incremental circled marker numbers 53 on any given side of the planar member 20 are the same distance from each horizontal ruled line 54 or each vertical ruled line 52 and the same distance from each other. The decremental circled marker numbers 58 are on the left perimeter 272 and the bottom perimeter 27 of the planar member 20 and are placed at different distances along the horizontal ruled lines 54 or vertical lines 52 from the incremental circled marker numbers 53, yet each decremental circled marker number 58 is of equal distance from any other decremental circled marker number 58. Incremental circled marker numbers 53 may be of a different color than decremental circled marker numbers 58. The reason for the difference in color and placement of the incremental marker numbers 53 from decremental circled marker numbers 58 pertains to allowing left-handed users of the device to read and measure along one set of distance marker numbers, while right-handed users might employ the other set of distance marker numbers for an equal measurement result with greater ease.

The hatch marks 51, vertical and horizontal ruled lines 52 and 54, and circled marker numbers 53 and 58 may be painted with various colors and hues, to further improve differentiation of markings for use in measuring with the device 10. The size of the hatch marks 51 and the vertical and horizontal ruled lines, 54 and 52, as well as the size of circles and circled numbers 53 and 58, may vary to still further improve differentiation of marking for use in measuring with the device 10.

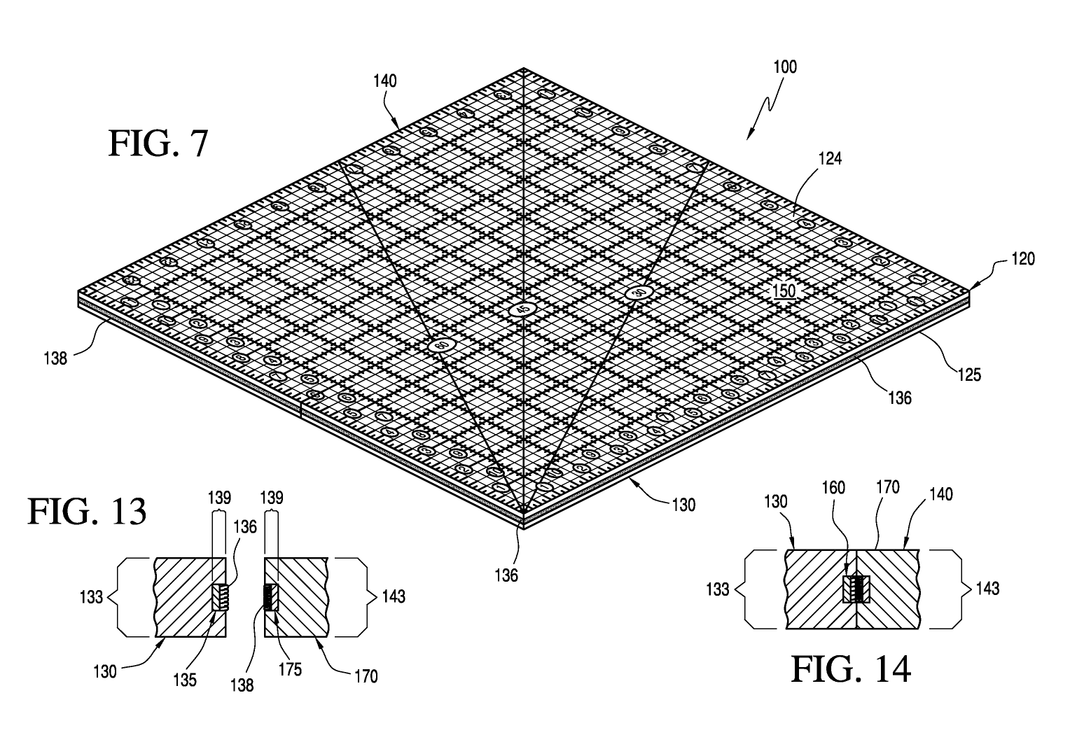

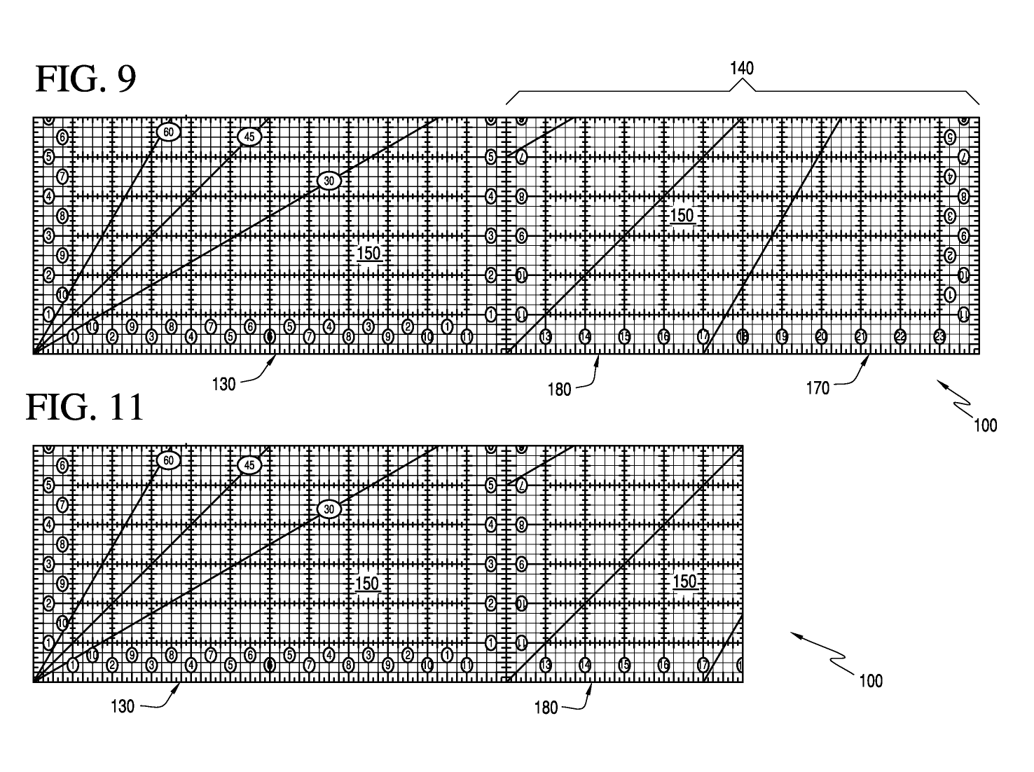

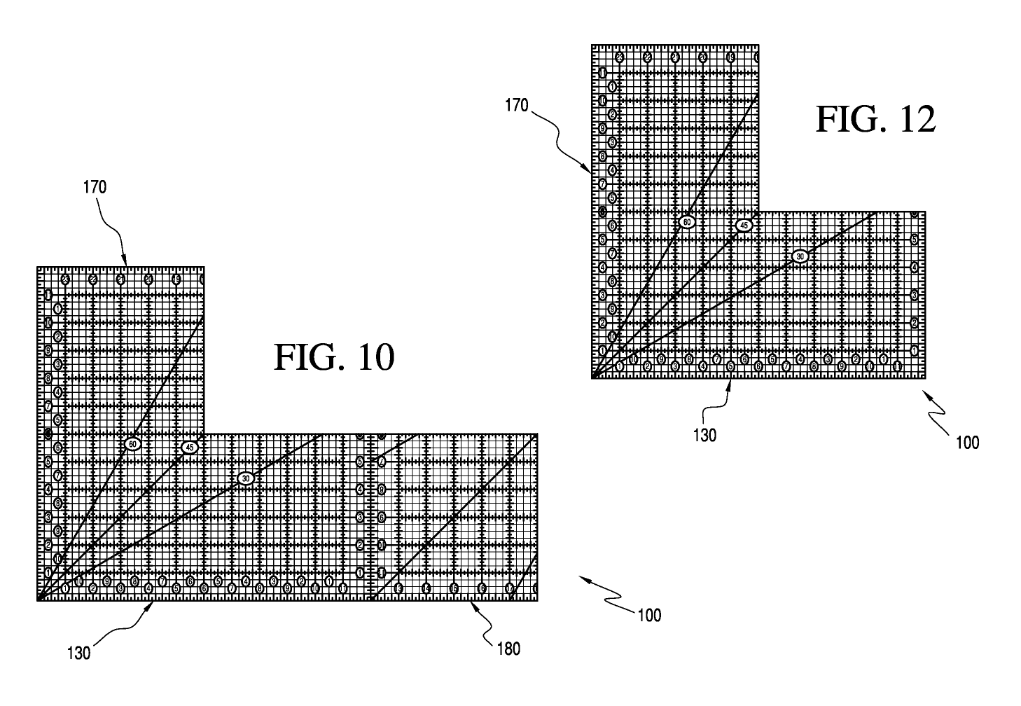

FIGS. 7 through 12 present a device 100. The device 100 is an alternative embodiment made in accordance with the present invention. The device 100 includes all the features and characteristics of the device 10. The device 100 includes a first member or planar member 120, indicia 150, and a plurality of connectors 160. The first member 120 includes a first surface 124, a second surface 125 a first portion 130 and a second portion 140. The first portion 130 also includes a perimeter 137.

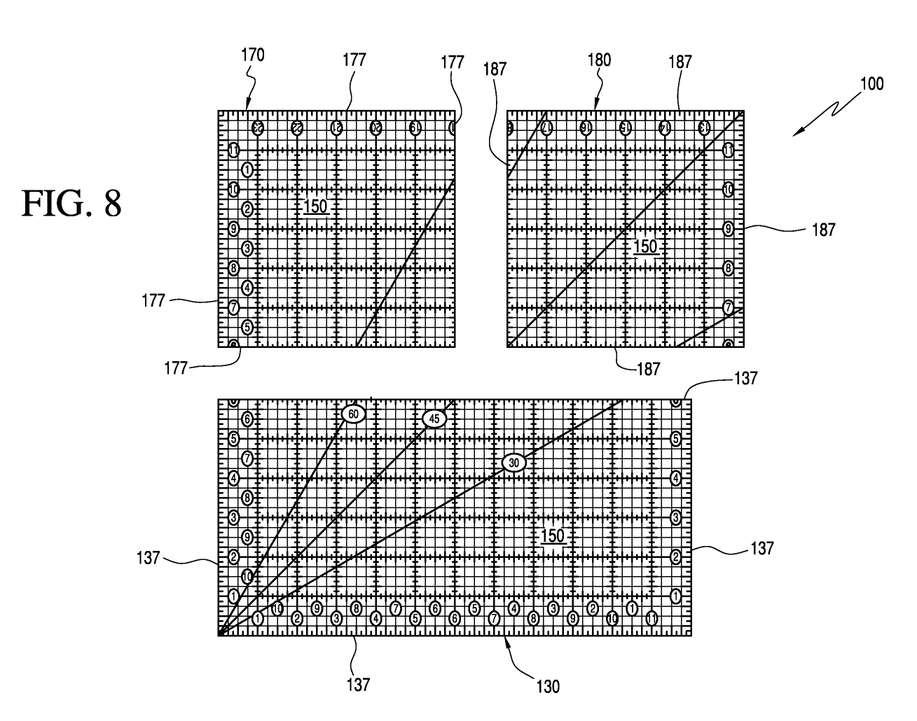

The device 100 is different from the device 10 in that the second portion 140 comprises two sub-portions 170 and 180, as shown in FIG. 8. Each of the two sub-portions 170 and 180 in this embodiment are square having a dimension of six inches by six inches. However, it should be appreciated that in other various exemplary embodiments, the two sub-portions could be other geometric shapes, such as rectangular or triangular.

The device 100 is further different from the device 10 in that the plurality of connectors 160 are of a hook and loop fastener type, verses the tongue and groove type of device 10. The two sub-portions 170 and 180 of the second portion 140 each have a perimeter 177 and 187 respectively.

Further, each of the two portions includes a thickness, 133, and 143, as shown in FIGS. 13 and 14. Along a center line (not shown) of the thicknesses of each of the portions 133 and 143 is a channel 135. For illustration, only the channel 135 of the first portion 130 and channel 175 of the first sub-portion 170 are shown in FIGS. 13 and 14. The channels 135 and 175 have a depth 139. In the present embodiment, the depth 139 of the channels 135 and 175 is about one-sixteenth of an inch. In the channel 139 of first portion 130 is disposed a hook portion 136 of the hook and loop fastener connector 160. Disposed in the channel 139 of the two sub-portions portions, 170 and 180 is a loop portion 138 of the hook and loop fastener 160.

The device 100, like the device 10 has a variety of positions within the same plane that the craftsman can use for the measuring and cutting of flat sheet material. The hook and loop fastener 160 of the device 100 allows the craftsman to quickly pull the portions 130, 170 and 180 apart from and reposition them for quick use in measuring and cutting sheet material. In addition to making the first, second and third planar positions, as in the device 10, the device 100 has fourth and fifth planar positions, as shown in FIGS. 11 and 12. The fourth position for the device 100 is a six by eighteen inches rectangle and the fifth position is a twelve by twelve inches L-shape.

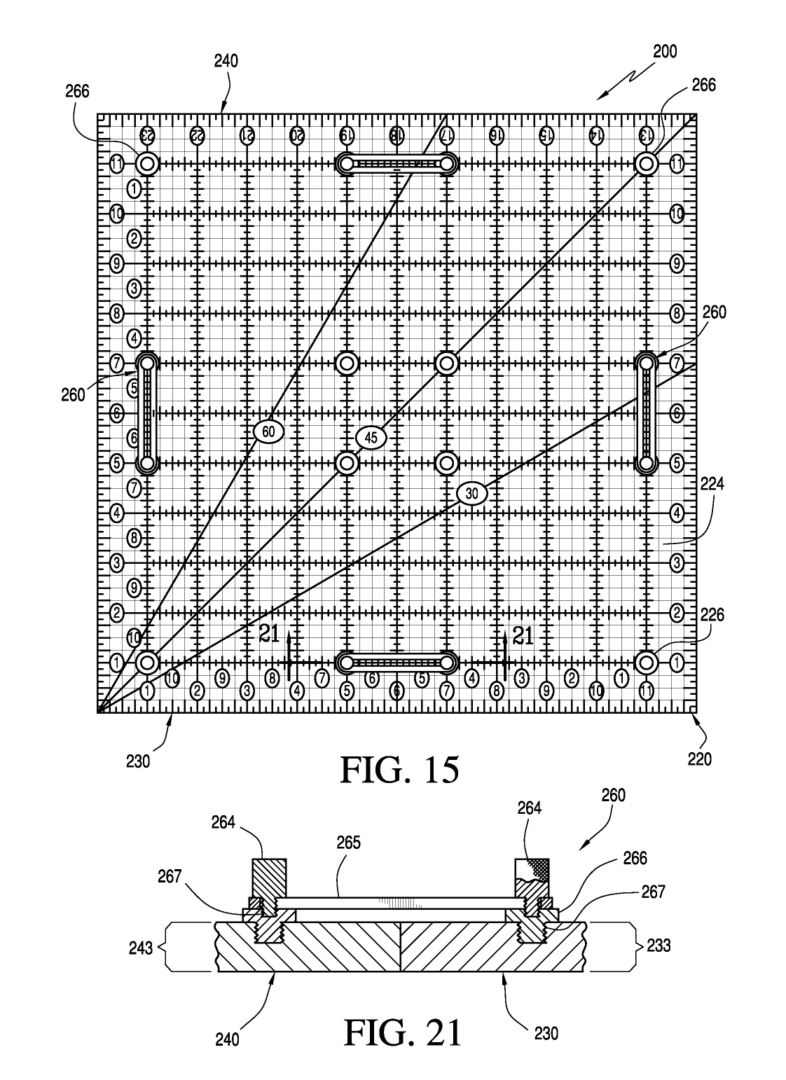

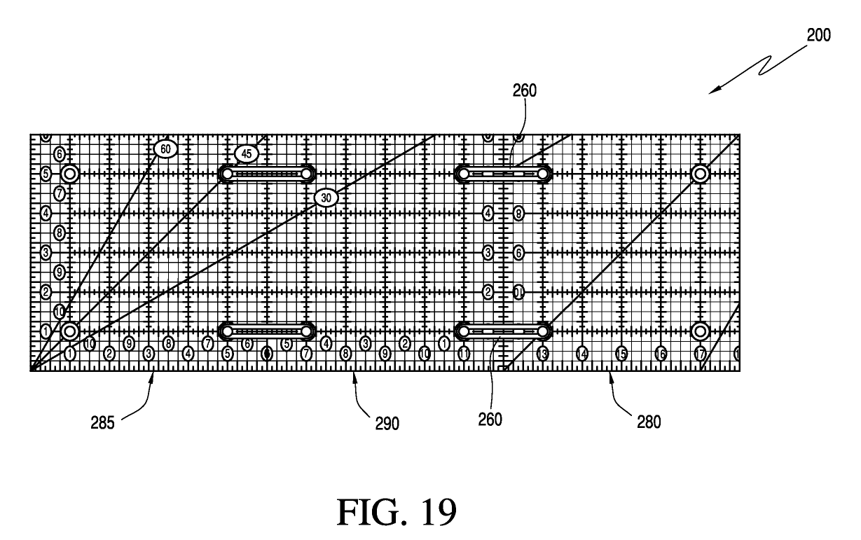

FIGS. 15 through 20 present a device 200. The device 200 is an alternative embodiment made in accordance with the present invention. The device 200 includes all the features and characteristics of the device 10. The device 200 includes a first member or planar member 220, indicia 250, and a plurality of connectors 260. The planar member 220 includes a first surface 224, a first portion 230 and a second portion 240.

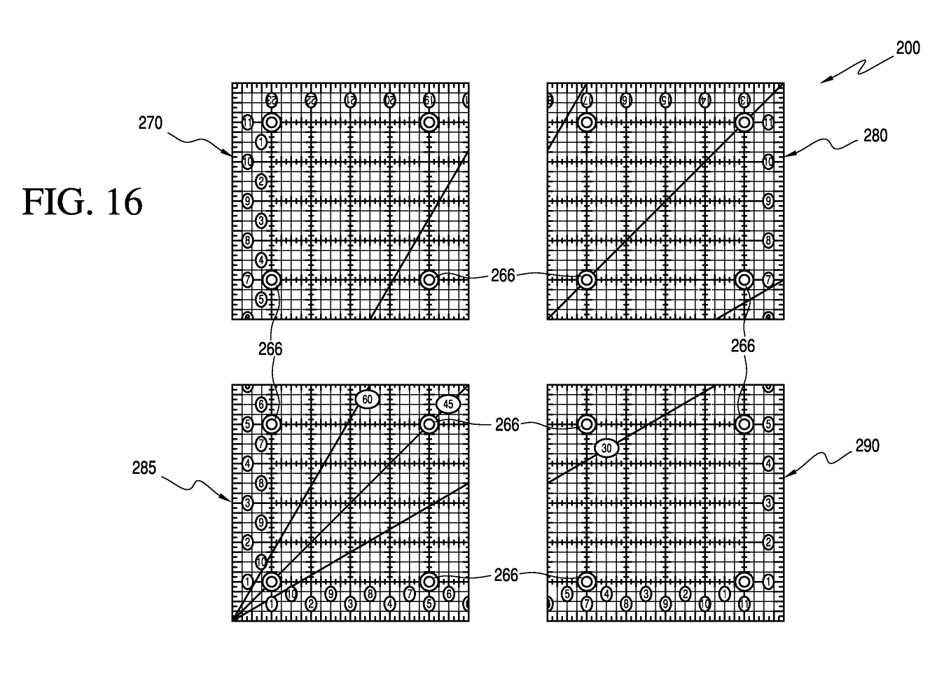

The device 200 is different from the device l in that the first portion 230 has two sub-portions 285 and 290, as shown in FIG. 16. Additionally, the second portion 240 has two sub-portions 270 and 280 as in device 100. Each of the four sub-portions, 285, 290, 270 and 280 in this embodiment are square having a dimension of six inches by six inches.

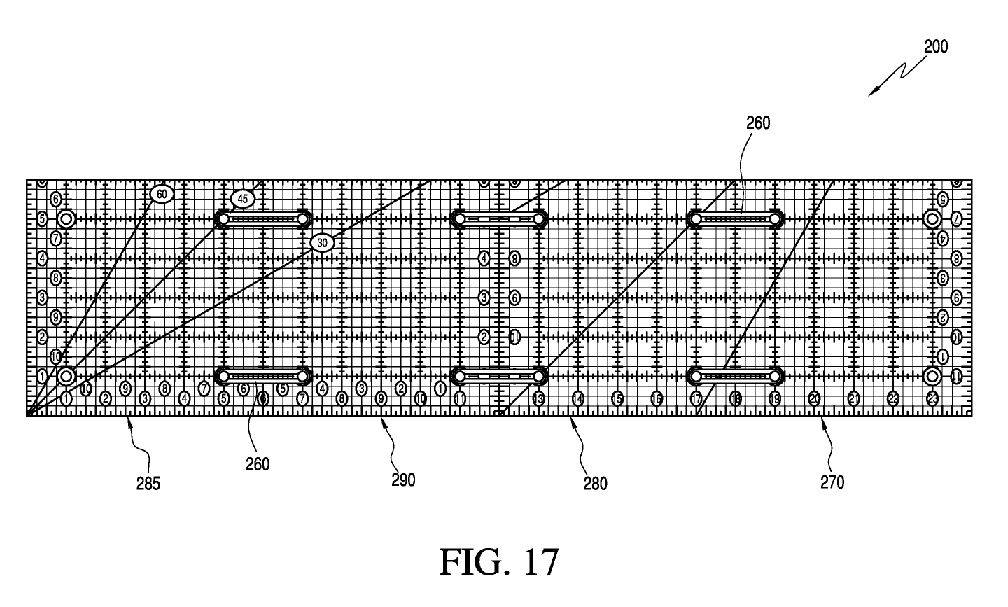

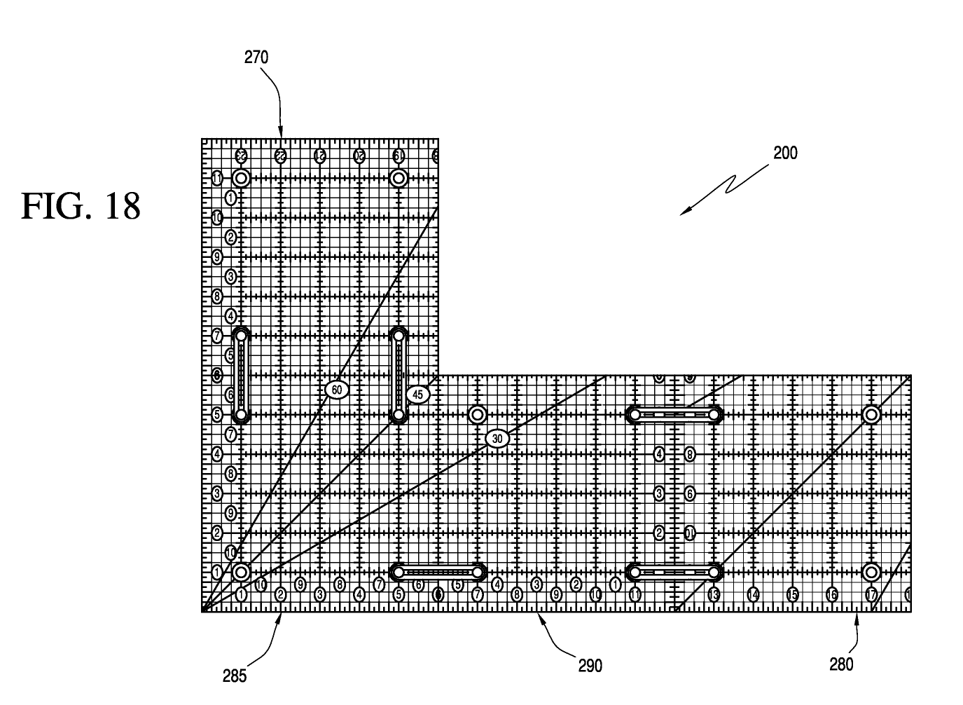

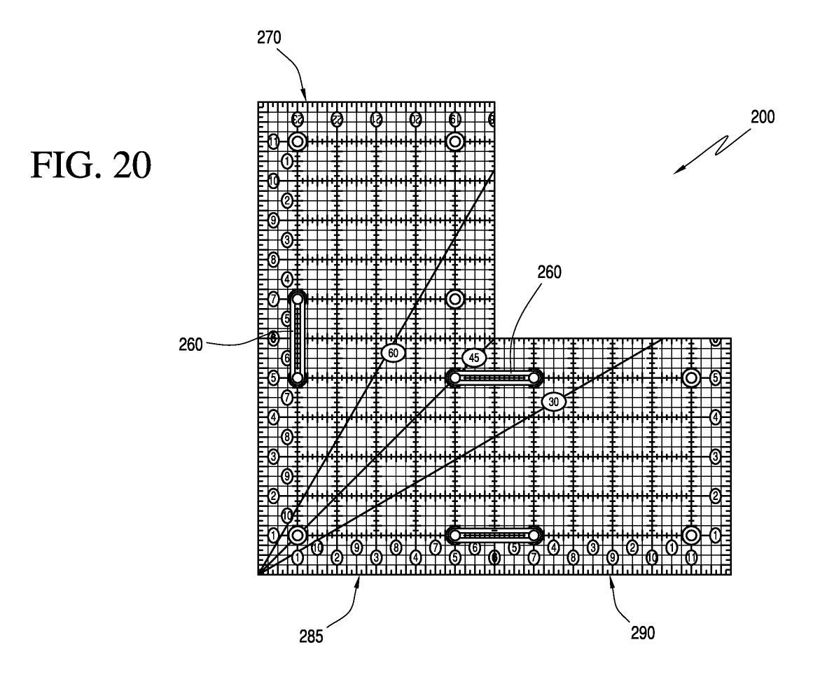

The four sub-portions 285, 290, 270 and 280 of the device 200 permits the user to select from a more varied choice of positions to form the device 200. The device 200 has a first planar position for twelve by twelve inches as in device 10. The device 200 also has a second planar position, as shown in FIG. 17 of six by twenty-four inches as in device 10. Also, the device 200 has a third position, as shown in FIG. 18 of an L-shape as in device 10, eighteen inches high by twelve inches wide. The device 200 has the advantage of other positions within the same plane such as a fourth position as shown in FIG. 18, of a rectangle six by eighteen inches, and a fifth position, as shown in FIG. 20 of an L-shape, twelve by twelve inches.

While the FIGS. 15 through 20 show the four sub-portions 285, 290, 270 and 280 making the five positions, it should be appreciated that the four sub-portions may be connected in any sequence to form the shapes desired by the user. Further, it should be appreciated that the user of the device 200 may form other shapes by using other various combinations of the four sub-portions.

Further, the device 200 employs a different type of plurality of connectors 260, as shown in FIG. 21. In this embodiment, the plurality of connectors 260 are a screw type with a knurled knob 264 and connecting bar 265, as shown in FIG. 21. Additionally, each of the four portions includes a plurality of threaded inserts 266. In this embodiment, the knurled knobs 264 are brass and include a threaded shaft 267 and are disposed in the connecting bar 265 at its distal ends. The threaded inserts 266 are brass and are operably configured to receive the threaded shaft 267 of the knurled knobs 264. The threaded inserts 266 are disposed on each of the first and second portions, 230 and 240.

In the present embodiment, eight threaded inserts 266 are disposed on each of the first and second portions 230 and 240. In regards to the first portion 230, four inserts 266 are disposed on the sub-portion 285 and four inserts 266 are disposed on the sub-portion 290. In regards to the second portion 240, four inserts are disposed on the sub-portion 270 and four inserts are disposed on the sub-portion 280.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A measuring device for flat sheet material comprising:
a first portion being planar and having a length, a width and a first surface;
a second portion being planar and having a first surface, wherein the second portion removably connects to the first portion in a first planar position along the length and removably connects to the first portion in a second position along the width within the same plane; and,
wherein the first and second portions have measuring indicia imprinted on the each of the first surfaces of the first and second portion.

2. The measuring device, as recited in claim 1, wherein the first and the second portions are equal sized rectangle shaped.

3. The measuring device, as recited in claim 1, wherein at least one of the first and the second portions further includes a first and second sub-portion, wherein the first and second sub-portions are each removably connected to each other and to at least one of the first and second portions in a third planar position and removably connects to a fourth planar position within the same plane.

4. The measuring device as recited in claim 3, wherein the first and second sub-portions are square in shape.

5. The measuring device, as recited in claim 1, wherein at least one of the first and second portions are constructed out of a transparent polycarbonate plastic.

6. The measuring device, as recited in claim 1, wherein the measuring indicia is English units

7. The measuring device, as recited in claim 1, wherein the measuring indicia includes delineated measurements in both incremented units and decremented units.

8. The measuring device, as recited in claim 1, further comprising a plurality of connectors disposed on the first and second portions and operably configured to removably connect the first and second portions in at least a first and second planar position.

9. The measuring device, as recited in claim 8, wherein the plurality of connectors is a tongue and groove type connector.

10. A device for measuring flat, flexible sheet material comprising:
a main body being planar and having a length, a width and a first surface, wherein the main body has at least two portions and the two portions are removably connectable to each other in a first position along the length and can be removably connected to each other along the width in a second position; and,
wherein the first surface of the main body includes indicia for measuring.

11. The device, as recited in claim 10, wherein the main body is transparent polycarbonate plastic.

12. The device, as recited in claim 10, wherein the at least two portions are equal sized rectangles.

13. The device, as recited in claim 10, wherein the indicia includes delineated measurements in both incremented units and decremented units.

14. The device, as recited in claim 10, further including a plurality of connectors, wherein the plurality of connectors are operably configured to connect the at least two portions together along at least one of the length and the width to create at least one of a first and second position.

15. The device, as recited in claim 14, wherein the plurality of connectors include a handle with threaded knobs at distal ends of the handle and operably configured to thread into the first portion and into the second portions.

16. A multi-pieced measuring device for flat, flexible sheet material, comprising:
a planar member having four removably connected portions and, a first surface;
measuring indicia imprinted on the first surface; and,
a plurality of connectors disposed on the planar member and operably configured to connect the four removably connected portions in a first planar position and removably connectable in a second planar position.

17. The multi-pieced measuring device, as recited in claim 16, wherein the four removably connected portions are square.

18. The multi-pieced measuring device, as recited in claim 16, wherein the four removably connected portions each include a perimeter and the plurality of connectors being a hook and loop fastener disposed along the perimeter of each of the four removably connected portions.

19. The multi-pieced measuring device, as recited in claim 16, wherein the planar member is transparent polycarbonate plastic.

20. The multi-pieced measuring device, as recited in claim 16, wherein the four removably connected portions further connect to form a third position and removably reconnect to form a fourth position.
